(19) United States
(12) Patent Application Publication
(10) Pub. No.: US 2026/0322245 A1
(43) Pub. Date: Oct. 15, 2026

(54) METHOD AND SYSTEM FOR REGULATING REDUCED SWITCH COUNT THREE-LEVEL INVERTER FOR STANDBY POWER SUPPLY SYSTEM

(71) Applicant: SHANDONG JIANZHU UNIVERSITY, Jinan (CN)

(72) Inventors: Changwei QIN, Jinan (CN); Xiaoyan LI, Jinan (CN); Chengdong LI, Jinan (CN); Lei YANG, Jinan (CN); Hongchao BAI, Jinan (CN); Dingguo AN, Jinan (CN); Dongjiang YANG, Jinan (CN)

(21) Appl. No.: 19/434,532

(22) Filed: Dec. 29, 2025

(30) Foreign Application Priority Data
Apr. 2, 2025 (CN) 2025104109567

(51) Int. Cl. H02M 1/084; H02M 1/00; H02M 1/44; H02M 7/5387

(52) U.S. Cl. CPC H02M 1/084; H02M 1/0009; H02M 1/44; H02M 7/53876

(57) ABSTRACT

A method for regulating reduced switch count three-level inverter (RSC-TLI) for standby power supply system, including: sampling load voltage and current, inductor current, upper and lower capacitor voltages on direct current side; selecting inductor current for decoupling operation, calculating expected output voltage of inverter according to deadbeat control principle, performing normalization processing; determining optimal large and small sectors based on amplitude and boundary conditions of expected output voltage; selecting low common-mode voltage vectors to synthesize virtual small and medium vectors based on discrete space vector modulation, to extend vector candidate set; determining switching sequence at next moment based on large and small sectors in which expected output voltage is located and voltage difference across upper and lower capacitors on direct current side, to balance neutral-point voltage and fix switching frequency; and calculating acting time of voltage vector based on value function and outputting duty ratio thereof, which are applied to switching devices of the inverter.

### CROSS-REFERENCE TO RELATED APPLICATIONS

The present invention claims priority to Chinese Patent Application No. 202510410956.7, filed with the China National Intellectual Property Administration on Apr. 2, 2025 and entitled “METHOD AND SYSTEM FOR REGULATING LOW-COST INVERTER FOR STANDBY POWER SUPPLY SYSTEM”, which is incorporated herein by reference in its entirety and constitutes a part of the present invention, for all purposes.

### TECHNICAL FIELD

The present invention belongs to the field of regulation technologies of standby power supply loop apparatus, and in particular, to a method and system for regulating a reduced switch count three-level inverter (RSC-TLI) for a standby power supply system.

### BACKGROUND

The description in this section merely provides background information related to the present invention and does not necessarily constitute the prior art.

The three-level inverter (TLI) has obvious advantages such as low voltage stress of a power switch, high quality of an output waveform, and a small volume of a filter, and is widely used in power supply and distribution systems. In addition, compared with the TLI with only an L filter, the TLI with an LC filter has advantages such as higher efficiency, lower harmonic content of an output waveform, and less electromagnetic interference. Therefore, the TLI with an LC filter is widely applied to an uninterruptible power supply (UPS) and an emergency power supply (EPS).

By using a coupled switching cell, a topology of a RSC-TLI reduces a quantity of power switches, reduces system costs, and has a wide application prospect in the field of standby power supply. A common-mode voltage is generated by a high-frequency switching action of the power switch. In a system including a distributed photovoltaic generation unit, leakage current is easily caused due to existence of a stray capacitance. This leads to distorted output current from the inverter and increased system power loss, and even poses a threat to personal safety. When a standby power supply system is applied to variable-frequency driving of a motor, affected by the common-mode voltage, the motor may induce a generated shaft voltage. This easily breaks down an insulating oil film within motor bearings, thereby damaging the motor bearings and enhancing electromagnetic interference to the system.

According to understanding of the inventor, the existing conventional linear regulation method for a RSC-TLI with an LC filter includes proportional integral (PI) control and proportional resonance (PR) control. However, performance of the method depends on a value of a gain module, and there are problems such as slow dynamic response and difficulty in realizing neutral-point potential balance. Model predictive control has obvious advantages in the following aspects, such as a fast dynamic response capability, a good anti-interference capability, and a flexible multi-target control capability. Therefore, the model predictive control is more suitable for application in the standby power supply system, to satisfy performance indicators of high reliability and rapid switching of the system.

However, due to a limitation of the topology itself, an original method for suppressing a common-mode voltage of the TLI cannot be applied to the topology. In addition, the existing model predictive control methods for the RSC-TLI are applicable to only a topology with an L filter, and cannot be directly applied to a topology with an LC filter. If the conventional model predictive control method is improved and applied to the topology with an LC filter, the following disadvantages exist, such as a high common-mode voltage, high harmonic content of a load voltage, an unfixed switching frequency, and a complex operation of a control algorithm.

### SUMMARY

To resolve the foregoing problems, the present invention provides a method and a system for regulating a RSC-TLI for a standby power supply system. The present invention can effectively suppress a common-mode voltage of the system, fix a switching frequency, reduce harmonic of a load voltage, and reduce an operation amount of a control algorithm, thereby obviously improving system performance.

According to some examples, a first solution of the present invention provides a method for regulating a RSC-TLI for a standby power supply system, and the following technical solutions are used.

The method for regulating the RSC-TLI for the standby power supply system, including:
obtaining, by a processor, a load voltage and current, an inductor current, and upper and lower capacitor voltages on a direct current side of the RSC-TLI at a current moment, and calculating an expected output voltage;
optimizing, by the processor, a vector candidate set by avoiding high common-mode voltage vectors, and synthesizing, based on discrete space vector modulation, a virtual small vector and a virtual medium vector to extend the vector candidate set, to obtain an updated vector candidate set;
respectively determining, by the processor, based on an amplitude relationship and a boundary condition of the expected output voltage in a 60° coordinate system, an optimal large sector and an optimal small sector at which the expected output voltage is located;

determining, by the processor, an initial switching sequence in the optimal small sector based on the updated vector candidate set and a voltage difference across capacitors on the direct current side;

calculating, by the processor, an optimal acting time of a selected basic voltage vector with a target of minimizing a load voltage tracking error, and optimizing the initial switching sequence based on minimizing a quantity of switching actions and balancing a neutral-point voltage on the direct current side, to obtain an optimal switching sequence;

converting, by the processor, the obtained optimal switching sequence into a pulse width modulation (PWM) drive signal controlling a power switching device of the RSC-TLI to be turned on and turned off, and sending the PWM drive signal to a gate of the power switching device; and controlling the power switching device to be turned on and turned off according to the PWM drive signal sent by the processor.

According to some examples, a second solution of the present invention provides a system for regulating a RSC-TLI for a standby power supply system, and the following technical solutions are used.

The system for regulating the RSC-TLI for the standby power supply system, including:
an expected output voltage calculation module, configured to: obtain a load voltage and current, an inductor current, and upper and lower capacitor voltages on a direct current side of the RSC-TLI at a current moment, and calculate an expected output voltage;
a vector candidate set determining module, configured to: optimize a vector candidate set by avoiding high common-mode voltage vectors, and synthesize, based on discrete space vector modulation, a virtual small vector and a virtual medium vector to extend the vector candidate set, to obtain an updated vector candidate set;
an optimal sector determining module, configured to respectively determine, based on an amplitude relationship and a boundary condition of the expected output voltage in a 60° coordinate system, an optimal large sector and an optimal small sector at which the expected output voltage is located;
an initial switching sequence design module, configured to determine an initial switching sequence in the optimal small sector based on the updated vector candidate set and a voltage difference across capacitors on the direct current side;
a neutral-point voltage balance and switching sequence optimization module, configured to: calculate an optimal acting time of a selected basic voltage vector with a target of minimizing a load voltage tracking error, and optimize the initial switching sequence based on minimizing a quantity of switching actions and balancing a neutral-point voltage on the direct current side, to output an optimal switching sequence;
a drive signal conversion module, configured to convert the optimal switching sequence that is output into a PWM drive signal that controls a power switching device of the RSC-TLI to be turned on and turned off;
a drive signal transmission module, configured to send the PWM drive signal to a gate of the power switching device, to control the power switching device to be turned on and turned off; and
the power switching device is controlled to be turned on and turned off according to the PWM drive signal sent by the drive signal transmission module.

According to some examples, a third solution of the present invention provides a computer-readable storage medium.

The computer-readable storage medium, having a computer program stored thereon, wherein when the program is executed by a processor, the steps of the method for regulating the RSC-TLI for the standby power supply system according to the first aspect are implemented.

According to some examples, a fourth solution of the present invention provides a computer device.

A computer device, including a memory, a processor, and a computer program that is stored in the memory and that can be run on the processor, wherein when the processor executes the program, the steps of the method for regulating the RSC-TLI for the standby power supply system according to the first aspect are implemented.

According to some examples, a fifth aspect of the present invention provides a computer program product or a computer program.

The computer program product or the computer program, including computer instructions, and the computer instructions are stored in a computer-readable storage medium;

wherein a processor of a computer device reads the computer instructions from a computer-readable storage medium, and the processor executes the computer instructions, to cause the computer device to perform the steps of the method for regulating the RSC-TLI for the standby power supply system according to the first aspect.

Compared with the prior art, the present invention has the following beneficial effects.

The present invention may reduce the common-mode voltage and improve system reliability. A concept of the virtual vector is introduced, and a plurality of vectors is used to synthesize the load voltage, thereby reducing the voltage ripple and improving power quality of the output voltage. The value function is used to determine the optimal acting time of the voltage vector required to synthesize the load voltage, to further reduce the voltage ripple. The switching sequence is tactfully designed to achieve the fixed switching frequency, thereby facilitating efficient filtering of the voltage harmonics. The switching sequence is flexibly selected, and the neutral-point voltage on the direct current side is skillfully controlled, to implement neutral-point voltage balance on the direct current side. The method for determining the optimal sector in the 60° coordinate system avoids complex trigonometric function calculation through simple value comparison, and simplifies an algorithm operation process, thereby greatly reducing complexity of the control algorithm.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a structural diagram of a RSC-TLI applicable to a standby power supply system;

FIG. 2 is a control block diagram of the RSC-TLI applicable to the standby power supply system according to the present invention;

FIG. 3 is a low common-mode basic space vector diagram of the RSC-TLI applicable to the standby power supply system according to the present invention;

FIG. 4 is an extended space vector diagram of the RSC-TLI applicable to the standby power supply system according to the present invention;

FIG. 5A shows a capacitor voltage, a line voltage, a load current, a load voltage, and a common-mode voltage on a direct current side of the RSC-TLI system applicable to the standby power supply system by using single-vector model predictive control according to the present invention;

FIG. 5B shows the capacitor voltage, the line voltage, the load current, the load voltage, and the common-mode voltage on the direct current side of the RSC-TLI system applicable to the standby power supply system by using optimal switching sequence model predictive control according to the present invention;

FIG. 5C shows the capacitor voltage, the line voltage, the load current, the load voltage, and the common-mode voltage on the direct current side of the RSC-TLI system applicable to the standby power supply system by using low common-mode model predictive control proposed in the present invention according to the present invention;

FIG. 6A shows fast Fourier transform (FFT) of the RSC-TLI applicable to the standby power supply system by using single-vector model predictive control according to the present invention;

FIG. 6B shows the FFT of the RSC-TLI applicable to the standby power supply system by using optimal switching sequence model predictive control according to the present invention;

FIG. 6C shows the FFT of the RSC-TLI applicable to the standby power supply system by using low common-mode model predictive control proposed in the present invention according to the present invention;

FIG. 7A shows a dynamic response waveform (DRW) of the RSC-TLI applicable to the standby power supply system by using single-vector model predictive control according to the present invention;

FIG. 7B shows the DRW of the RSC-TLI applicable to the standby power supply system by using optimal switching sequence model predictive control according to the present invention; and

FIG. 7C shows the DRW of the RSC-TLI applicable to the standby power supply system by using low common-mode model predictive control proposed in the present invention according to the present invention.

### DETAILED DESCRIPTION

The present invention is further described below with reference to the accompanying drawings and the examples.

It should be pointed out that the following detailed descriptions are all illustrative and are intended to provide further description of the present invention. Unless otherwise specified, all technical and scientific terms used in this specification have the same meanings as those usually understood by a person of ordinary skill in the art to which the present invention belongs.

It should be noted that the terms used herein are merely used for describing specific implementation modes, and are not intended to limit exemplary implementation modes of the present invention. As used herein, the singular form is intended to include the plural form, unless the context clearly indicates otherwise. In addition, it should further be understood that terms “comprise/comprising” and/or “include/including” used in this specification indicate that there are features, steps, operations, devices, components, and/or combinations thereof.

The examples in the present invention and features in the examples may be combined with each other if there is no conflict.

### Example 1

The present example provides a method for regulating a RSC-TLI for a standby power supply system. The present example is described by using an example in which the method is applied to a server. It is to be understood that the method may also be applied to a terminal, or may be applied to a system including a terminal and a server, and is implemented through interaction between the terminal and the server. The server may be an independent physical server, a server cluster or a distributed system including a plurality of physical servers, or a cloud server providing basic cloud computing services such as a cloud service, a cloud database, cloud computing, a cloud function, cloud storage, a network server, cloud communication, a middleware service, a domain name service, a security service, a CDN, big data, and an artificial intelligence platform. The terminal may be a smartphone, a tablet computer, a notebook computer, a desktop computer, a smart speaker, a smart watch, or the like, but is not limited thereto. The terminal and the server may be directly or indirectly connected in a wired or wireless communication manner. This is not limited in this application. In the present example, the method includes:
obtaining, by a processor, a load voltage and current, an inductor current, and upper and lower capacitor voltages on a direct current side of a RSC-TLI at a current moment, and calculating an expected output voltage;
optimizing, by the processor, a vector candidate set by avoiding high common-mode voltage vectors, and synthesizing, based on discrete space vector modulation, a virtual small vector and a virtual medium vector to extend the vector candidate set, to obtain an updated vector candidate set;
respectively determining, by the processor, based on an amplitude relationship and a boundary condition of the expected output voltage in a 60° coordinate system, an optimal large sector and an optimal small sector at which the expected output voltage is located;
determining, by the processor, an initial switching sequence in the optimal small sector based on the updated vector candidate set and a voltage difference across capacitors on the direct current side;
calculating, by the processor, an optimal acting time of a selected basic voltage vector with a target of minimizing a load voltage tracking error, and optimizing the initial switching sequence based on minimizing a quantity of switching actions and balancing a neutral-point voltage on the direct current side, to obtain an optimal switching sequence;
converting, by the processor, the obtained optimal switching sequence into a PWM drive signal controlling a power switching device of the RSC-TLI to be turned on and turned off, and sending the PWM drive signal to a gate of the power switching device;
controlling the power switching device to be turned on and turned off according to the PWM drive signal sent by the processor.

The present invention provides a high-performance regulation method for the RSC-TLI applicable to the standby power supply system, to suppress harmonics of a common-mode voltage and an output voltage of the RSC-TLI. The method of the present invention is applicable to both the discharged state and a charged state of a standby power supply. A detailed description is provided below by using an example in which the standby power supply is in a discharging state, and the description is further provided in conjunction with the accompanying drawings and examples.

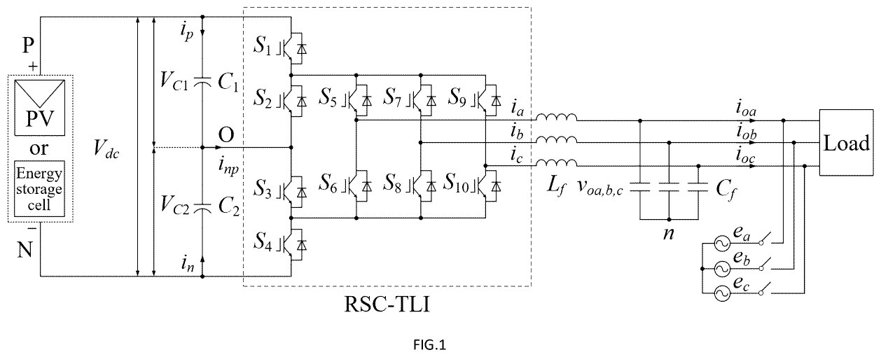

In one or more implementation modes, a target control object of the high-performance regulation method for the RSC-TLI applicable to the standby power supply system is the RSC-TLI, refer to FIG. 1. FIG. 1 is the structural diagram of the RSC-TLI applicable to the standby power supply system.

In an ideal case, a direct current side voltage V_{dc} is equally divided by C₁ and C₂. A neutral point (that is, a point O in FIG. 1) on the direct current side is selected as a reference point. As shown in FIG. 1, for ease of description, a common module is further subdivided into an upper bridge arm module and a lower bridge arm module, and output voltages thereof are represented by V_{H} and V_{L} respectively. A working principle of the common module may be expressed as:

$$\{ \begin{matrix}{V}_{H} = {S}_{1} \cdot {V}_{dc} / 2 \\ {V}_{L} = - {S}_{4} \cdot {V}_{dc} / 2\end{matrix} . \qquad ( 1 )$$

The common module is connected to a three-phase independent module through V_{H} and V_{L}. The common module is connected to a filter and a load through a midpoint of the three-phase independent module. A three-phase output voltage of the RSC-TLI applicable to the standby power supply system is expressed as:

$$[ \begin{matrix}{v}_{ao} \\ {v}_{bo} \\ {v}_{co}\end{matrix} ] = [ \begin{matrix}{S}_{5} & {S}_{6} \\ {S}_{7} & {S}_{8} \\ {S}_{9} & {S}_{10}\end{matrix} ] [ \begin{matrix}{V}_{H} \\ {V}_{L}\end{matrix} ] ; \qquad ( 2 )$$

wherein, Sₓ (x=1, 2, . . . , 10) satisfies the following relationship:

$${S}_{x} = \{ \begin{matrix}1 , & if {S}_{x} is on \\ 0 , & if {S}_{x} is off\end{matrix} , x = 1 , 2 , … , 10. \qquad ( 3 )$$

Therefore, different switch states are arranged and combined with each other, so that the system has 21 voltage vectors in total. A common-mode voltage of the system may be expressed as:

$${C}_{CM} = \frac{{v}_{ao} + {v}_{bo} + {v}_{co}}{3} . \qquad ( 4 )$$

A power switch may be implemented by using any controllable power electronic switch. Specifically, an insulated-gate bipolar transistor (IGBT) may be used, or a transistor in another form may be used for implementation mode. This may be specifically selected according to an actual requirement of a person skilled in the art.

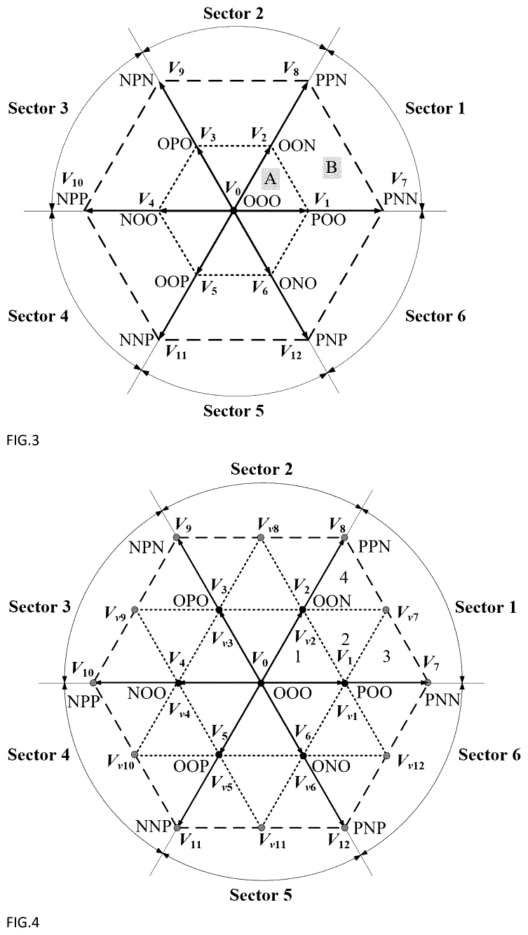

In the present invention, the common-mode voltage of the system is suppressed by discarding a basic voltage vector with a common-mode voltage amplitude exceeding V_{dc}/6, thereby enhancing stability of the system. In addition, due to existence of the common module, the foregoing inverter can output only two types of level signals at most at a same moment, so that a medium vector cannot be generated. Therefore, the RSC-TLI has only thirteen available low common-mode basic voltage vectors, as shown in FIG. 3.

To address the foregoing problems, the present invention provides a method for controlling a model predictive voltage of the RSC-TLI applicable to the standby power supply system. In the present example, the method includes:
obtaining, based on a state equation of an LC-type power conversion circuit at an alternating current port of the RSC-TLI, a discrete mathematic model of the LC-type power conversion circuit in a 60° coordinate system through discretization and coordinate transformation;
approximating an estimation result of the inductor current as an actual value of the inductor current by using a “one-step estimation method”, to derive a gradient equation of the load voltage;
synthesizing, according to a basic principle of discrete space vector modulation, a virtual vector, to synchronously implement flexible control of the neutral-point voltage on the direct current side, reduce an output voltage ripple, and reduce calculation difficulty of an optimal acting time;
sampling a load voltage, a load current, an inductor current, and upper and lower capacitor voltages on a direct current side of the RSC-TLI, and performing coordinate transformation processing;
calculating an expected output voltage of the RSC-TLI, and determining an optimal large sector and an optimal small sector based on an amplitude relationship and a boundary condition of the expected output voltage in the 60° coordinate system;
calculating an optimal acting time of each vector at a moment k+1 based on minimizing an output voltage tracking error;
determining a switching mode at a next moment based on a voltage difference across upper and lower capacitors on the direct current side, to balance a neutral-point voltage on the direct current side and obtain an optimal switching sequence by optimizing the switching sequence, thereby achieving a fixed switching frequency; and
generating a corresponding drive signal based on the optimal switching sequence, to control a switching device of the RSC-TLI to be turned on and turned off.

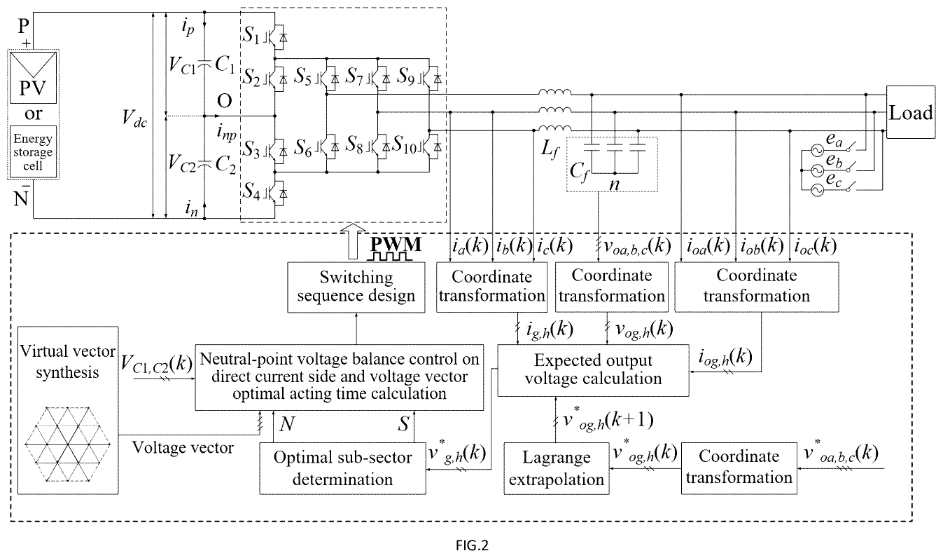

FIG. 2 is a control block diagram of the RSC-TLI applicable to the standby power supply system according to the present invention, and specifically includes:

### A. Building a System Dynamic Model

Based on FIG. 1 and according to Kirchhoff's law, a continuous dynamic equation of the system is obtained, and its expression is as follows:

$$\frac{d}{dt} [ \begin{matrix}v \\ i\end{matrix} ] = [ \begin{matrix}\frac{1}{{C}_{f}} & 0 \\ 0 & \frac{1}{{L}_{f}}\end{matrix} ] [ \begin{matrix}i \\ v\end{matrix} ] + [ \begin{matrix}- \frac{1}{{C}_{f}} & 0 \\ 0 & - \frac{1}{{L}_{f}}\end{matrix} ] [ \begin{matrix}{i}_{0} \\ {v}_{0}\end{matrix} ] . \qquad ( 5 )$$

To reduce complexity of a control algorithm, in the present invention, the following coordinate transformation is performed. A transformation formula is as follows:

$$[ \begin{matrix}{x}_{g} \\ {x}_{h}\end{matrix} ] = \frac{2}{3} [ \begin{matrix}1 & - 1 & 0 \\ 0 & 1 & - 1\end{matrix} ] [ \begin{matrix}{x}_{a} \\ {x}_{b} \\ {x}_{c}\end{matrix} ] , x = v , i ; \qquad ( 6 )$$

wherein, [xₐ x_{b} x_{c}]^{T} is a coordinate of an alternating voltage or an alternating current in an a, b, c-three-phase coordinate system; and [x_{g} xₙ] is a coordinate of an alternating voltage or an alternating current in the 60° coordinate system.

After the foregoing coordinate transformation, a continuous dynamic equation of the system in the 60° coordinate system may be obtained, and its expression is as follows:

$$\{ \begin{matrix}\frac{{dv}_{og}}{dt} = \frac{{i}_{g}}{{C}_{f}} - \frac{{i}_{og}}{{C}_{f}} \\ \frac{{dv}_{oh}}{dt} = \frac{{i}_{h}}{{C}_{f}} - \frac{{i}_{oh}}{{C}_{f}}\end{matrix} ; \qquad ( 7 )$$

$$\{ \begin{matrix}\frac{{di}_{g}}{dt} = \frac{{v}_{g}}{{L}_{f}} - \frac{{v}_{og}}{{L}_{f}} \\ \frac{{di}_{h}}{dt} = \frac{{v}_{h}}{{L}_{f}} - \frac{{v}_{oh}}{{L}_{f}}\end{matrix} ; \qquad ( 8 )$$

wherein, v_{og} and vₒₕ are coordinates of the load voltage in the 60° coordinate system, i_{g} and iₕ are coordinates of the inductor current in the 60° coordinate system, i_{og} and iₒₕ are coordinates of the load current in the 60° coordinate system, v_{g} and vₕ are coordinates of the output voltage in the 60° coordinate system, and L_{f} and C_{f} are a filter inductor and a filter capacitor respectively.

As a further technical solution, the dynamic equation of the system is discretized according to the forward Euler method, to obtain an expression of a discrete dynamic model in the 60° coordinate system as follows:

$$\{ \begin{matrix}\frac{{v}_{og} ( k + 1 ) - {v}_{og} ( k )}{{T}_{s}} = \frac{{i}_{g} ( k )}{{C}_{f}} - \frac{{i}_{og} ( k )}{{C}_{f}} \\ \frac{{v}_{oh} ( k + 1 ) - {v}_{oh} ( k )}{{T}_{s}} = \frac{{i}_{h} ( k )}{{C}_{f}} - \frac{{i}_{oh} ( k )}{{C}_{f}}\end{matrix} ; \qquad ( 9 )$$

$$\{ \begin{matrix}\frac{{i}_{og} ( k + 1 ) - {i}_{og} ( k )}{{T}_{s}} = \frac{{v}_{g} ( k )}{{L}_{f}} - \frac{{v}_{og} ( k )}{{L}_{f}} \\ \frac{{i}_{oh} ( k + 1 ) - {i}_{oh} ( k )}{{T}_{s}} = \frac{{v}_{h} ( k )}{{L}_{f}} - \frac{{v}_{oh} ( k )}{{L}_{f}}\end{matrix} ; \qquad ( 10 )$$

wherein, v_{og}(k+1), vₒₕ(k+1), i_{og}(k+1), iₒₕ(k+1), v_{og}(k), vₒₕ(k), i_{og}(k), and iₒₕ(k) are respectively expressions of the load voltage and the load current at the moment k+1 and the moment k in the 60° coordinate system; i_{g}(k), iₕ(k), v_{g}(k), and vₕ(k) are respectively expressions of the inductor current and the output voltage at the moment k in the 60° coordinate system; and Tₛ represents a sampling period.

Apparently, based on formula (9) and formula (10), system state variables: the inductor current and the load voltage are cross-coupled to each other. In addition, the output voltage cannot directly control the load voltage. System control performance is limited by the foregoing coupling relationship.

As a further technical solution, to keep the voltage on the direct current side balanced, it may be obtained from FIG. 1 that a capacitor current and a capacitor voltage on the direct current side satisfy the following relational expression:

$$\{ \begin{matrix}{i}_{p} = {C}_{1} \frac{{dV}_{C 1}}{dt} \\ {i}_{n} = {C}_{2} \frac{{dV}_{C 2}}{dt}\end{matrix} ; \qquad ( 11 )$$

wherein, C₁ and C₂ are respectively upper and lower capacitors of a distributed direct current power supply unit, V_{C1} and V_{C2} are respectively voltages of the upper and lower capacitors, and iₚ and iₚ are respectively currents flowing through the upper and lower capacitors.

Similarly, according to the forward Euler method, formula (11) is discretized to obtain a discrete dynamic model of the distributed direct current power supply unit as follows:

$$\{ \begin{matrix}{i}_{p} = {C}_{1} \frac{{V}_{C 1} ( k + 1 ) - {V}_{C 1} ( k )}{{T}_{s}} \\ {i}_{n} = {C}_{2} \frac{{V}_{C 2} ( k + 1 ) - {V}_{C 2} ( k )}{{T}_{s}}\end{matrix} . \qquad ( 12 )$$

Therefore, based on formula (12), expressions of the voltages of the upper and lower capacitors of the distributed direct current power supply unit at the moment k+1 may be obtained, which may be expressed as:

$$\{ \begin{matrix}{V}_{C 1} ( k + 1 ) = {V}_{C 1} ( k ) - \frac{{i}_{p} {T}_{s}}{{C}_{1}} \\ {V}_{C 2} ( k + 1 ) = {V}_{C 2} ( k ) - \frac{{i}_{n} {T}_{s}}{{C}_{2}}\end{matrix} . \qquad ( 13 )$$

In addition, iₚ and iₙ satisfy the following relational expression:

$${i}_{n p} = {i}_{p} - {i}_{n} ; \qquad ( 14 )$$

wherein, iₙₚ is a current flowing through a neutral point O.

In addition, based on formula (13) and formula (14), a voltage difference V_{diff}(k+1) across the upper and lower capacitors of the distributed direct current power supply unit at the moment k+1 may be obtained, which is expressed as:

$${V}_{diff} ( k + 1 ) = {V}_{C 1} ( k + 1 ) - {V}_{C 2} ( k + 1 ) = ( {V}_{C 1} ( k ) - {V}_{C 2} ( k ) ) - \frac{{i}_{n p} {T}_{s}}{{C}_{1}} . \qquad ( 15 )$$

Therefore, an additional current sensor is required to predict the voltage difference between the upper and lower capacitors of the distributed direct current power supply unit at the moment k+1, which increases costs and complexity of system design.

### B. System Decoupling Control and Load Voltage Gradient Calculation

The optimal switching sequence is a control algorithm based on a change gradient of a selected voltage vector to a controlled object. Therefore, to accurately predict the load voltage, a gradient of the basic voltage vector to the load voltage needs to be obtained first. However, for the RSC-TLI with an LC filter, an output voltage v_{gh} of the inverter directly affect the inductor current i_{gh}. Therefore, the load voltage v_{ogh} cannot be directly controlled. Therefore, to obtain a load voltage gradient corresponding to each basic voltage vector and predict the load voltage, a decoupling operation needs to be performed.

In the present invention, a “one-step estimation” strategy is used to implement a decoupling operation between state variables. Specifically, in the strategy, it is assumed that after a voltage vector is applied in an entire control period, an estimated value of the inductor current is used as an inductor current at the moment k. The mathematic model of the “one-step estimation” strategy may be expressed as:

$$\{ \begin{matrix}{i}_{g}^{∧} ( k ) = \frac{{T}_{s}}{{L}_{f}} ( {v}_{g} ( k ) - {v}_{o g} ( k ) ) + {i}_{g} ( k ) \\ {i}_{h}^{∧} ( k ) = \frac{{T}_{s}}{{L}_{f}} ( {v}_{h} ( k ) - {v}_{o h} ( k ) ) + {i}_{h} ( k )\end{matrix} ; \qquad ( 16 )$$

wherein,

$${i}_{g}^{∧} ( k ) and {i}_{h}^{∧} ( k )$$

are estimated values of the inductor current at the moment k in the 60° coordinate system.

It may be obtained based on formula (7) that, a calculation formula of the load voltage gradient before decoupling is as follows:

$$\{ \begin{matrix}{f}_{vog} = \frac{{i}_{g}}{{C}_{f}} - \frac{{i}_{o g}}{{C}_{f}} \\ {f}_{voh} = \frac{{i}_{h}}{{C}_{f}} - \frac{{i}_{o h}}{{C}_{f}}\end{matrix} ; \qquad ( 17 )$$

wherein, f_{vog} and fᵥₒₕ are load voltage gradients in the 60° coordinate system. Formula (16) is substituted into formula (17) for a decoupling operation, and discretization processing is performed on the load voltage gradient according to the forward Euler method. A discretization expression of the load voltage gradient is expressed as:

$$\{ \begin{matrix}\begin{matrix}{f}_{vog} = \frac{1}{{C}_{f}} ( {i}_{g}^{∧} ( k ) - {i}_{og} ( k ) ) \\ = \frac{1}{{C}_{f}} [ {i}_{g} ( k ) + \frac{{T}_{s}}{{L}_{f}} ( {v}_{g} ( k ) - {v}_{og} ( k ) ) - {i}_{og} ( k ) ]\end{matrix} \\ \begin{matrix}{f}_{voh} = \frac{1}{{C}_{f}} ( {i}_{h}^{∧} ( k ) - {i}_{oh} ( k ) ) \\ = \frac{1}{{C}_{f}} [ {i}_{h} ( k ) + \frac{{T}_{s}}{{L}_{f}} ( {v}_{h} ( k ) - {v}_{oh} ( k ) ) - {i}_{oh} ( k ) ]\end{matrix} ;\end{matrix} \qquad ( 18 )$$

### C. Building a Prediction Model

To simultaneously achieve control objectives of low output voltage ripple and reduction of algorithm complexity, in the present invention, three voltage vectors Vᵥ₁, Vᵥ₂, and Vᵥ₃ are selected in each control cycle to synthesize the reference voltage, and acting times of the voltage vectors are t₁, t₂, and t₃ respectively. The acting time satisfies the following relational expression:

$${t}_{1} + {t}_{2} + {t}_{3} = {T}_{s} . \qquad ( 19 )$$

Based on formula (18), predicted values v_{og}(k+1) and vₒₕ(k+1) of the load voltage at the moment k+1 in the 60° coordinate system may be expressed as:

$$[ \begin{matrix}{v}_{og} ( k + 1 ) \\ {v}_{oh} ( k + 1 )\end{matrix} ] = [ \begin{matrix}{v}_{og} ( k ) \\ {v}_{oh} ( k )\end{matrix} ] + [ \begin{matrix}{f}_{Vvg , 1} & {f}_{Vvg , 2} & {f}_{Vvg , 3} \\ {f}_{Vvh , 1} & {f}_{Vvh , 2} & {f}_{Vvh , 3}\end{matrix} ] [ \begin{matrix}{t}_{1} \\ {t}_{2} \\ {t}_{3}\end{matrix} ] ; \qquad ( 20 )$$

wherein, f_{Vvg,1}, f_{Vvg,2}, f_{Vvg,3}, f_{Vvh,1}, f_{Vvh,2}, and f_{Vvh,3} are respectively load voltage gradients of voltage vectors Vᵥ₁, Vᵥ₂, and Vᵥ₃ on an axis g and an axis h.

Predicted values

$${v}_{og}^{*} ( k + 1 ) and {v}_{oh}^{*} ( k + 1 )$$

of the reference voltage at the moment k+1 are obtained by using the second-order Lagrange extrapolation theorem:

$$\{ \begin{matrix}{v}_{og}^{*} ( k + 1 ) = 3 {v}_{og}^{*} ( k ) - 3 {v}_{og}^{*} ( k - 1 ) + {v}_{og}^{*} ( k - 2 ) \\ {v}_{oh}^{*} ( k + 1 ) = 3 {v}_{oh}^{*} ( k ) - 3 {v}_{oh}^{*} ( k - 1 ) + {v}_{oh}^{*} ( k - 2 )\end{matrix} ; \qquad ( 21 )$$

To simultaneously achieve multi-target control of a low ripple of an output voltage and maintaining neutral-point voltage balance on the direct current side, an initial value function J₀ may be expressed as:

$${J}_{0} = \vert {v}_{o g}^{*} ( k + 1 ) - {v}_{o g} ( k + 1 ) \vert + \vert {v}_{o h}^{*} ( k + 1 ) - {v}_{o h} ( k + 1 ) \vert + λ \vert {V}_{diff} ( k + 1 ) \vert ; \qquad ( 22 )$$

wherein, λ is a weight factor for maintaining neutral-point voltage balance on the direct current side.

### D. Synthesizing a Virtual Vector and Balance Control of a Neutral-Point Voltage

### (1) Synthesizing a Virtual Small Vector

It can be learned based on FIG. 3 that, after the high common-mode voltage vectors are avoided, existing small vectors no longer have a redundant state, causing great difficulties in balance control of the neutral-point voltage on the direct current side. For the foregoing problem, newly synthesized six virtual small vectors and the existing small vectors form a new redundancy relationship, to flexibly control a direct current neutral-point voltage.

It can be learned based on FIG. 3 that, among the existing basic voltage vectors, the neutral-point voltage on the direct current side is affected by only the small vector. Each virtual small vector is synthesized from three basic voltage vectors: V₁, V₂, and V₃. To ensure that a newly synthesized virtual small vector and a corresponding small vector are within one control period, iₙₚ is of an equal amplitude and opposite polarities, and the foregoing three basic voltage vectors need to satisfy the following constraint condition:

$${i}_{npv 1} + {i}_{npv 2} + {i}_{npv 3} = - {i}_{npv} ; \qquad ( 23 )$$

wherein, iₙₚᵥ₁, iₙₚᵥ₂, and iₙₚᵥ₃ are iₙₚ respectively generated by basic voltage vectors V₁, V₂, and V₃, and iₙₚᵥ is iₙₚ generated by an actual small vector corresponding to a virtual small vector, that is, a current flowing through the neutral point O.

The virtual small vectors synthesized in the present invention and basic voltage vectors thereof are combined as shown in Table 1.

Table 1 Virtual small vectors and basic voltage vectors thereof

| Virtual small vectors | Basic voltage vectors | iₙₚ |
|---|---|---|
| Vᵥ₁ | [ONO], [OON], [PNN] | iₐ |
| Vᵥ₂ | [POO], [OPO], [PPN] | i_{c} |
| Vᵥ₃ | [OON], [NOO], [NPN] | i_{b} |
| Vᵥ₄ | [OPO], [OOP], [NPP] | iₐ |
| Vᵥ₅ | [NOO], [ONO], [NNP] | i_{c} |
| Vᵥ₆ | [OOP], [POO], [PNP] | i_{b} |

The virtual small vector Vᵥₓ(x=1, . . . , 6) and the basic voltage vector thereof need to satisfy the following constraint condition:

$$\{ \begin{matrix}{V}_{vx} = {\sum }_{i = 1}^{3} {V}_{i} {t}_{i} \\ {t}_{1} = {t}_{2} = {t}_{3} = \frac{{T}_{vx}}{3}\end{matrix} ; \qquad ( 24 )$$

wherein, Tᵥₓ is an acting time of the virtual small vector Vᵥₓ, and t₁, t₂, and t₃ are respectively acting times of the basic voltage vectors V₁, V₂, and V₃.

### (2) Synthesizing a Virtual Medium Vector

It can be learned from FIG. 3 that when the reference voltage is located in a region B, to ensure an optimal acting time of each vector, a partial derivative calculation needs to be performed on selected four voltage vectors for three times based on the value function, which may undoubtedly increase algorithm complexity. The region B may be further subdivided into two sub-sectors based on the virtual medium vector. In a newly divided sub-sector, the partial derivative calculation needs to be performed only twice, to determine the optimal acting time of each vector, thereby reducing the algorithm complexity. To prevent the virtual medium vector from affecting the neutral-point voltage on the direct current side, only two large vectors are selected from newly synthesized virtual medium vectors as basic voltage vectors.

The virtual medium vectors and the basic voltage vectors are shown in Table 2.

Table 2 Virtual medium vectors and basic voltage vectors thereof

| Virtual medium vectors | Basic voltage vectors | iₙₚ |
|---|---|---|
| Vᵥ₇ | [PNN], [PPN] | 0 |
| Vᵥ₈ | [PPN], [NPN] | 0 |
| Vᵥ₉ | [NPN], [NPP] | 0 |
| Vᵥ₁₀ | [NPP], [NNP] | 0 |
| Vᵥ₁₁ | [NNP], [PNP] | 0 |
| Vᵥ₁₂ | [PNP], [PNN] | 0 |

The virtual medium vector Vᵥₓ(x=7, . . . , 12) and the basic voltage vector thereof need to satisfy the following constraint condition:

$$\{ \begin{matrix}{V}_{vx} = {\sum }_{i = 1}^{2} {V}_{i} {t}_{i} \\ {t}_{1} = {t}_{2} = \frac{{T}_{vx}}{2}\end{matrix} ; \qquad ( 25 )$$

wherein, Tᵥₓ is an acting time of the virtual medium vector Vᵥₓ, and t₁ and t₂ are respectively acting times of the basic voltage vectors V₁ and V₂.

### (3) Balance Control of a Neutral-Point Voltage on a Direct Current Side

FIG. 4 is an extended space vector diagram of the RSC-TLI applicable to the standby power supply system in the present example. It can be learned based on FIG. 4 that, the RSC-TLI applicable to the standby power supply system has a total of 25 voltage vectors after being optimized.

It should be noted that, two different switching sequences may be generated in each small sector, and have a same impact on the load voltage, but have opposite impacts on the neutral-point voltage on the direct current side. A switching sequence including an N-type small vector is selected when the neutral-point voltage on the direct current side is high; and a switching sequence including a P-type small vector is selected when the neutral-point voltage on the direct current side is low. The two switching sequences may be used to eliminate the weight factor λ in formula (22). Therefore, a new value function may be expressed as:

$$J = \vert {v}_{o g}^{*} ( k + 1 ) - {v}_{o g} ( k + 1 ) \vert + \vert {v}_{o h}^{*} ( k + 1 ) - {v}_{o h} ( k + 1 ) \vert . \qquad ( 26 )$$

It can be learned based on formula (26) that, there is no weight factor in the new value function, and therefore, no additional current sampling circuit on the direct current side is needed.

### E. Calculation of an Optimal Acting Time of a Voltage Vector

A basic requirement of model prediction is minimizing a value function. With reference to formula (20), formula (21), and formula (26), the value function J may be expressed as an equation about t₁ and t₂, and partial derivative calculation is performed on the value function J, to obtain an optimal solution of t₁ and t₂. A calculation formula of the optimal acting time of the voltage vector is as follows:

$$\{ \begin{matrix}\frac{\partial J ( {t}_{1} , {t}_{2} )}{\partial {t}_{1}} = 0 \\ \frac{\partial J ( {t}_{1} , {t}_{2} )}{\partial {t}_{2}} = 0\end{matrix} . \qquad ( 27 )$$

Formula (27) is solved, and explicit solutions of optimal acting times t₁, t₂, and t₃ may be expressed as:

$$\{ \begin{matrix}\begin{matrix}{t}_{1} = \frac{( {f}_{Vvh , 2} - {f}_{Vvh , 3} ) {E}_{g} + ( {f}_{Vvg , 3} - {f}_{Vvg , 2} ) {E}_{h} + ( {f}_{Vvg , 2} {f}_{Vvh , 3} - {f}_{Vvg , 3} {f}_{Vvh , 2} ) {T}_{s}}{( {f}_{Vvh , 2} - {f}_{Vvh , 3} ) {f}_{Vvg , 1} + ( {f}_{Vvh , 3} - {f}_{Vvh , 1} ) {f}_{Vvg , 2} + ( {f}_{Vvh , 1} - {f}_{Vvh , 2} ) {f}_{Vvg , 3}} \\ {t}_{2} = \frac{( {f}_{Vvh , 3} - {f}_{Vvh , 1} ) {E}_{g} + ( {f}_{Vvg , 1} - {f}_{Vvg , 3} ) {E}_{h} + ( {f}_{Vvg , 3} {f}_{Vvh , 1} - {f}_{Vvg , 1} {f}_{Vvh , 3} ) {T}_{s}}{( {f}_{Vvh , 2} - {f}_{Vvh , 3} ) {f}_{Vvg , 1} + ( {f}_{Vvh , 3} - {f}_{Vvh , 1} ) {f}_{Vvg , 2} + ( {f}_{Vvh , 1} - {f}_{Vvh , 2} ) {f}_{Vvg , 3}}\end{matrix} \\ {t}_{3} = {T}_{s} - {t}_{1} - {t}_{2}\end{matrix} ; \qquad ( 28 )$$

wherein,

$${E}_{g} = {V}_{o g}^{*} ( k + 1 ) - {V}_{o g} ( k ) , and {E}_{h} = {V}_{o h}^{*} ( k + 1 ) - {V}_{o h} ( k ) .$$

### F. Determination of Optimal Sub-Sectors

If acting times of all switching sequences are still calculated by a conventional method for each control period, the complexity of the control algorithm is greatly increased, thereby limiting the control algorithm to be applied to the field of standby power supply. Therefore, in the present invention, expected output voltages

$${V}_{g}^{*} ( k ) and {V}_{h}^{*} ( k )$$

of the RSC-TLI in the 60° coordinate system are first obtained through deadbeat control. With reference to formula (16) to formula (18), the expected output voltages may be expressed as:

$$\{ \begin{matrix}{V}_{g}^{*} ( k ) = \frac{{L}_{f}}{{T}_{s}} ( \frac{{C}_{f}}{{T}_{s}} {E}_{g} + {i}_{o g} ( k ) - {i}_{g} ( k ) ) + {v}_{o g} ( k ) \\ {V}_{h}^{*} ( k ) = \frac{{L}_{f}}{{T}_{s}} ( \frac{{C}_{f}}{{T}_{s}} {E}_{h} + {i}_{o h} ( k ) - {i}_{h} ( k ) ) + {v}_{o h} ( k )\end{matrix} . \qquad ( 29 )$$

Normalization processing is performed on

$${V}_{g}^{*} ( k ) and {V}_{h}^{*} ( k )$$

based on V_{dc}/3. Expected output voltages on which the normalization processing is performed are

$${V}_{g}^{∧} ( k ) and {V}_{h}^{∧} ( k ) :$$

$$\{ \begin{matrix}{V}_{g}^{∧} ( k ) = {V}_{g}^{*} ( k ) / ( {V}_{d c} / 3 ) \\ {V}_{h}^{∧} ( k ) = {V}_{h}^{*} ( k ) / ( {V}_{d c} / 3 )\end{matrix} . \qquad ( 30 )$$

Further, to simplify calculation, in sector conversion, the reference voltage is rotated into a sector 1. A relational expression of expected output voltages

$${V}_{g}^{R} ( k ) and {V}_{h}^{R} ( k )$$

obtained after sector conversion and the expected output voltages

$${V}_{g}^{∧} ( k ) and {V}_{h}^{∧} ( k )$$

on which the normalization processing is performed is as follows:

$$[ \begin{matrix}{V}_{g}^{R} ( k ) \\ {V}_{h}^{R} ( k )\end{matrix} ] = {[ \begin{matrix}1 & 1 \\ - 1 & 0\end{matrix} ]}^{N - 1} [ \begin{matrix}{V}_{g}^{∧} ( k ) \\ {V}_{h}^{∧} ( k )\end{matrix} ] ; \qquad ( 31 )$$

wherein, N is a quantity of large sectors.

### (1) Division of a Large Sector

Firstly, an optimal large sector N may be determined briefly and rapidly based on amplitude conditions of

$${V}_{g}^{∧} ( k ) and {V}_{h}^{∧} ( k )$$

in the 60° coordinate system. Table 3 shows different large sectors and corresponding amplitude conditions.

Table 3 Correspondence between amplitude conditions of expected output voltages and different large sectors

| N | ${V}_{g}^{⋀}$ | ${V}_{h}^{⋀}$ | ${V}_{g}^{⋀} + {V}_{h}^{⋀}$ |
|---|---|---|---|
| 1 | >0 | >0 | — |
| 2 | <0 | >0 | >0 |
| 3 | <0 | >0 | <0 |
| 4 | <0 | <0 | — |
| 5 | >0 | <0 | <0 |
| 6 | >0 | <0 | >0 |

### (2) Division of a Small Sector

Secondly, an optimal small sector S may be further determined in combination with boundary conditions of

$${V}_{g}^{R} ( k ) and {V}_{h}^{R} ( k )$$

the 60° coordinate system. Table 4 shows different small sectors and corresponding boundary conditions.

Table 4 Correspondence between boundary conditions of expected output voltages and different small sectors

| S | ${V}_{g}^{R}$ | ${V}_{h}^{R}$ | ${V}_{g}^{R} + {V}_{h}^{R}$ |
|---|---|---|---|
| 1 | 0< | 0< | <1 |
| 2 | <1 | <1 | 1< |
| 3 | 1< | 0< | <2 |
| 4 | 0< | 1< | 1< |

### G. Designing a Switching Sequence

Through sector division, in the foregoing method, the acting time of the voltage vector needs to be calculated only once, and there is no need for a plurality of times of rolling comparison calculation, thereby greatly simplifying the control algorithm.

The switching sequence is designed in consideration of factors such as reducing output voltage harmonic content, maintaining neutral-point voltage balance on the direct current side, and fixing a switching frequency.

When the expected output voltage is located in the first small sector of sector 1, and V_{C1}<V_{C2}, the switching sequence is designed as:
[OOO]-[OON]-[PNN]-[ONO]-[PNN]-[OON]-[OOO].

When the expected output voltage is located in the first small sector of sector 1, and V_{C1}>V_{C2}, the switching sequence is designed as:
[OOO]-[POO]-[PPN]-[OPO]-[PPN]-[POO]-[OOO].

When the expected output voltage is located in the second small sector of sector 1, and V_{C1}<V_{C2}, the switching sequence is designed as:
[OON]-[PPN]-[PNN]-[ONO]-[PNN]-[PPN]-[OON].

When the expected output voltage is located in the second small sector of sector 1, and V_{C1}>V_{C2}, the switching sequence is designed as:
[POO]-[PNN]-[PPN]-[OPO]-[PPN]-[PNN]-[POO].

When the expected output voltage is located in the third small sector of sector 1, and V_{C1}<V_{C2}, the switching sequence is designed as:
[OON]-[PPN]-[PNN]-[ONO]-[PNN]-[PPN]-[OON].

When the expected output voltage is located in the third small sector of sector 1, and V_{C1}>V_{C2}, the switching sequence is designed as: [PPN]-[PNN]-[POO]-[PNN]-[PPN].

When the expected output voltage is located in the fourth small sector of sector 1, and V_{C1}<V_{C2}, the switching sequence is designed as: [PNN]-[PPN]-[OON]-[PPN]-[PNN].

When the expected output voltage is located in the fourth small sector of sector 1, and V_{C1}>V_{C2}, the switching sequence is designed as:
[POO]-[PNN]-[PPN]-[OPO]-[PPN]-[PNN]-[POO].

When the expected output voltage is located in the first small sector of sector 2, and V_{C1}<V_{C2}, the switching sequence is designed as:
[OOO]-[OON]-[NPN]-[NOO]-[NPN]-[OON]-[OOO].

When the expected output voltage is located in the first small sector of sector 2, and V_{C1}>V_{C2}, the switching sequence is designed as:
[OOO]-[OPO]-[PPN]-[POO]-[PPN]-[OPO]-[OOO].

When the expected output voltage is located in the second small sector of sector 2, and V_{C1}<V_{C2}, the switching sequence is designed as:
[OON]-[PPN]-[NPN]-[NOO]-[NPN]-[PPN]-[OON].

When the expected output voltage is located in the second small sector of sector 2, and V_{C1}>V_{C2}, the switching sequence is designed as:
[OPO]-[NPN]-[PPN]-[POO]-[PPN]-[NPN]-[OPO].

When the expected output voltage is located in the third small sector of sector 2, and V_{C1}<V_{C2}, the switching sequence is designed as: [NPN]-[PPN]-[OON]-[PPN]-[NPN].

When the expected output voltage is located in the third small sector of sector 2, and V_{C1}>V_{C2}, the switching sequence is designed as:
[OPO]-[NPN]-[PPN]-[POO]-[PPN]-[NPN]-[OPO].

When the expected output voltage is located in the fourth small sector of sector 2, and V_{C1}<V_{C2}, the switching sequence is designed as:
[OON]-[PPN]-[NPN]-[NOO]-[NPN]-[PPN]-[OON].

When the expected output voltage is located in the fourth small sector of sector 2, and V_{C1}>V_{C2}, the switching sequence is designed as: [PPN]-[NPN]-[OPO]-[NPN]-[PPN].

When the expected output voltage is located in the first small sector of sector 3, and V_{C1}<V_{C2}, the switching sequence is designed as:
[OOO]-[NOO]-[NPN]-[OON]-[NPN]-[NOO]-[OOO].

When the expected output voltage is located in the first small sector of sector 3, and V_{C1}>V_{C2}, the switching sequence is designed as:
[OOO]-[OPO]-[NPP]-[OOP]-[NPP]-[OPO]-[OOO].

When the expected output voltage is located in the second small sector of sector 3, and V_{C1}<V_{C2}, the switching sequence is designed as:
[NOO]-[NPP]-[NPN]-[OON]-[NPN]-[NPP]-[NOO].

When the expected output voltage is located in the second small sector of sector 3, and V_{C1}>V_{C2}, the switching sequence is designed as:
[OPO]-[NPN]-[NPP]-[OOP]-[NPP]-[NPN]-[OPO].

When the expected output voltage is located in the third small sector of sector 3, and V_{C1}<V_{C2}, the switching sequence is designed as:
[NOO]-[NPP]-[NPN]-[OON]-[NPN]-[NPP]-[NOO].

When the expected output voltage is located in the third small sector of sector 3, and V_{C1}>V_{C2}, the switching sequence is designed as: [NPP]-[NPN]-[OPO]-[NPN]-[NPP].

When the expected output voltage is located in the fourth small sector of sector 3, and V_{C1}<V_{C2}, the switching sequence is designed as: [NPN]-[NPP]-[NOO]-[NPP]-[NPN].

When the expected output voltage is located in the fourth small sector of sector 3, and V_{C1}>V_{C2}, the switching sequence is designed as:
[OPO]-[NPN]-[NPP]-[OOP]-[NPP]-[NPN]-[OPO].

When the expected output voltage is located in the first small sector of sector 4, and V_{C1}<V_{C2}, the switching sequence is designed as:
[OOO]-[NOO]-[NNP]-[ONO]-[NNP]-[NOO]-[OOO].

When the expected output voltage is located in the first small sector of sector 4, and V_{C1}>V_{C2}, the switching sequence is designed as:
[OOO]-[OOP]-[NPP]-[OPO]-[NPP]-[OOP]-[OOO].

When the expected output voltage is located in the second small sector of sector 4, and V_{C1}<V_{C2}, the switching sequence is designed as:
[NOO]-[NPP]-[NNP]-[ONO]-[NNP]-[NPP]-[NOO].

When the expected output voltage is located in the second small sector of sector 4, and V_{C1}>V_{C2}, the switching sequence is designed as:
[OOP]-[NNP]-[NPP]-[OPO]-[NPP]-[NNP]-[OOP].

When the expected output voltage is located in the third small sector of sector 4, and V_{C1}<V_{C2}, the switching sequence is designed as: [NNP]-[NPP]-[NOO]-[NPP]-[NNP].

When the expected output voltage is located in the third small sector of sector 4, and V_{C1}>V_{C2}, the switching sequence is designed as:
[OOP]-[NNP]-[NPP]-[OPO]-[NPP]-[NNP]-[OOP].

When the expected output voltage is located in the fourth small sector of sector 4, and V_{C1}<V_{C2}, the switching sequence is designed as:
[NOO]-[NPP]-[NNP]-[ONO]-[NNP]-[NPP]-[NOO].

When the expected output voltage is located in the fourth small sector of sector 4, and V_{C1}>V_{C2}, the switching sequence is designed as: [NPP]-[NNP]-[OOP]-[NNP]-[NPP].

When the expected output voltage is located in the first small sector of sector 5, and V_{C1}<V_{C2}, the switching sequence is designed as:
[OOO]-[ONO]-[NNP]-[NOO]-[NNP]-[ONO]-[OOO].

When the expected output voltage is located in the first small sector of sector 5, and V_{C1}>V_{C2}, the switching sequence is designed as:
[OOO]-[OOP]-[PNP]-[POO]-[PNP]-[OOP]-[OOO].

When the expected output voltage is located in the second small sector of sector 5, and V_{C1}<V_{C2}, the switching sequence is designed as:
[ONO]-[PNP]-[NNP]-[NOO]-[NNP]-[PNP]-[ONO].

When the expected output voltage is located in the second small sector of sector 5, and V_{C1}>V_{C2}, the switching sequence is designed as:
[OOP]-[NNP]-[PNP]-[POO]-[PNP]-[NNP]-[OOP].

When the expected output voltage is located in the third small sector of sector 5, and V_{C1}<V_{C2}, the switching sequence is designed as:
[ONO]-[PNP]-[NNP]-[NOO]-[NNP]-[PNP]-[ONO].

When the expected output voltage is located in the third small sector of sector 5, and V_{C1}>V_{C2}, the switching sequence is designed as: [PNP]-[NNP]-[OOP]-[NNP]-[PNP].

When the expected output voltage is located in the fourth small sector of sector 5, and V_{C1}<V_{C2}, the switching sequence is designed as: [NNP]-[PNP]-[ONO]-[PNP]-[NNP].

When the expected output voltage is located in the fourth small sector of sector 5, and V_{C1}>V_{C2}, the switching sequence is designed as:
[OOP]-[NNP]-[PNP]-[POO]-[PNP]-[NNP]-[OOP].

When the expected output voltage is located in the first small sector of sector 6, and V_{C1}<V_{C2}, the switching sequence is designed as:
[OOO]-[ONO]-[PNN]-[OON]-[PNN]-[ONO]-[OOO].

When the expected output voltage is located in the first small sector of sector 6, and V_{C1}>V_{C2}, the switching sequence is designed as:
[OOO]-[POO]-[PNP]-[OOP]-[PNP]-[POO]-[OOO].

When the expected output voltage is located in the second small sector of sector 6, and
V_{C1}<V_{C2}, the switching sequence is designed as:
[ONO]-[PNP]-[PNN]-[OON]-[PNN]-[PNP]-[ONO].

When the expected output voltage is located in the second small sector of sector 6, and V_{C1}>V_{C2}, the switching sequence is designed as:
[POO]-[PNN]-[PNP]-[OOP]-[PNP]-[PNN]-[POO].

When the expected output voltage is located in the third small sector of sector 6, and V_{C1}<V_{C2}, the switching sequence is designed as: [PNN]-[PNP]-[ONO]-[PNP]-[PNN].

When the expected output voltage is located in the third small sector of sector 6, and V_{C1}>V_{C2}, the switching sequence is designed as:
[POO]-[PNN]-[PNP]-[OOP]-[PNP]-[PNN]-[POO].

When the expected output voltage is located in the fourth small sector of sector 6, and V_{C1}<V_{C2}, the switching sequence is designed as:
[ONO]-[PNP]-[PNN]-[OON]-[PNN]-[PNP]-[ONO].

When the expected output voltage is located in the fourth small sector of sector 6, and V_{C1}>V_{C2}, the switching sequence is designed as: [PNP]-[PNN]-[POO]-[PNN]-[PNP].

The switching sequence is converted into a drive signal of a power switch, to control the RSC-TLI system to operate.

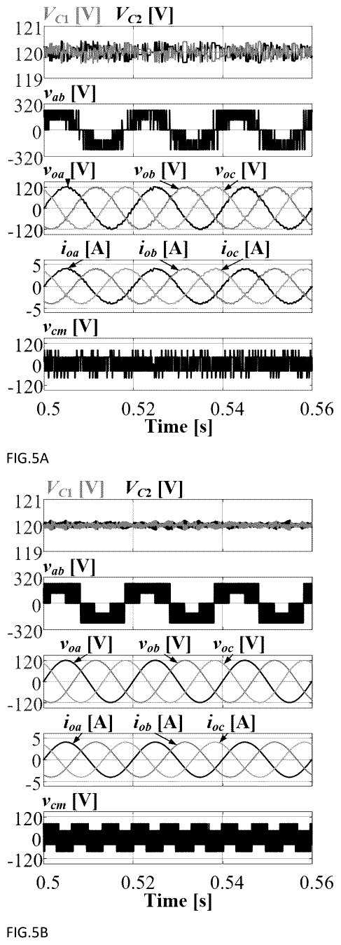

FIG. 5A, FIG. 5B, and FIG. 5C show the capacitor voltage, the line voltage, the load voltage, the load current, and the common-mode voltage on the direct current side of the RSC-TLI applicable to a standby power supply system according to the present invention by using single-vector model predictive control, optimal switching sequence model predictive control, and low common-mode model predictive control proposed herein. In addition, total harmonic distortions of the load voltage for the three methods are respectively 4.47%, 0.39%, and 0.42%. Obviously, compared with the existing single-vector model predictive control method, the proposed method and the optimal switching sequence model predictive control method significantly reduce an output voltage ripple and improve output power quality. Furthermore, the proposed method reduces an amplitude of the common-mode voltage to half that of a conventional model predictive control method, thereby enhancing stability of the system. In the proposed method, balance of a neutral-point voltage on the direct current side is implemented by flexibly selecting a small vector and a virtual small vector for function.

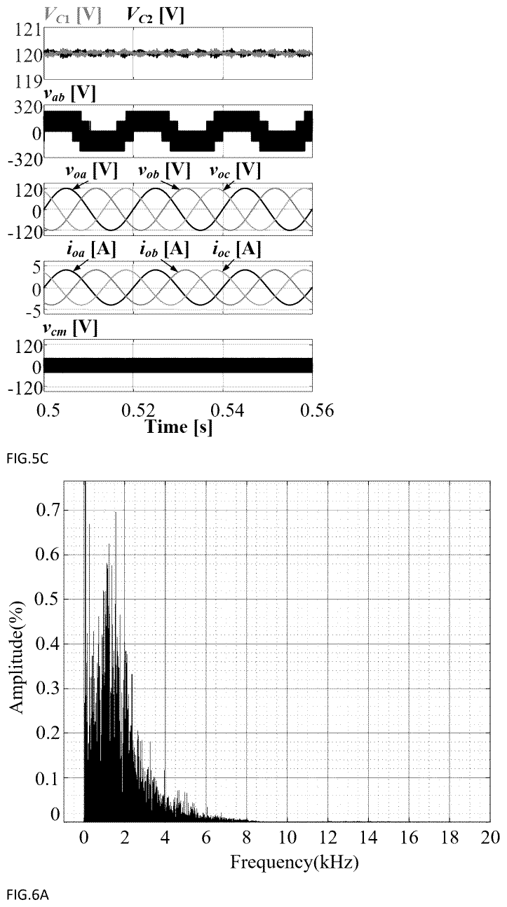

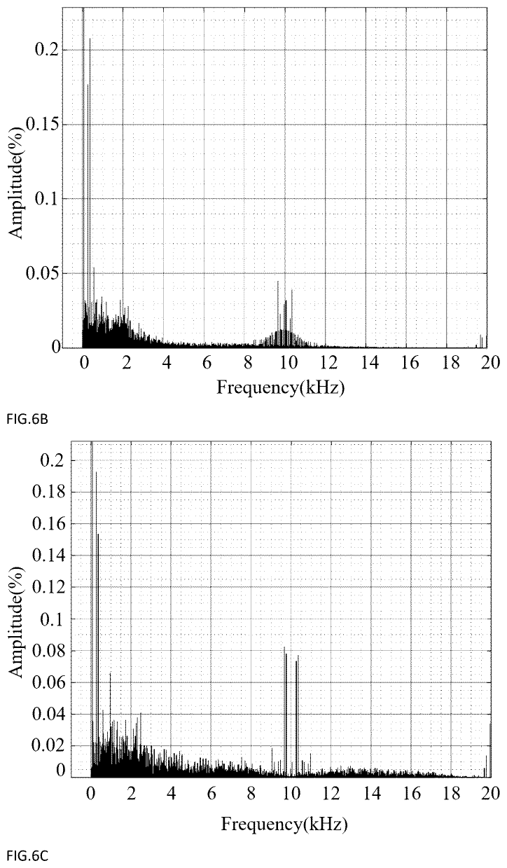

FIG. 6A, FIG. 6B, and FIG. 6C show fast Fourier analysis of the RSC-TLI applicable to a standby power supply system according to the present invention by adopting single-vector model predictive control, optimal switching sequence model predictive control, and low common-mode model predictive control proposed in the present invention. Compared with the single-vector model predictive control method, voltage harmonics in the proposed method and the optimal switching sequence model predictive control method are smaller, and are more concentratedly distributed at a switching frequency and a frequency multiplication thereof, thereby facilitating filter parameter design for more efficient filtering.

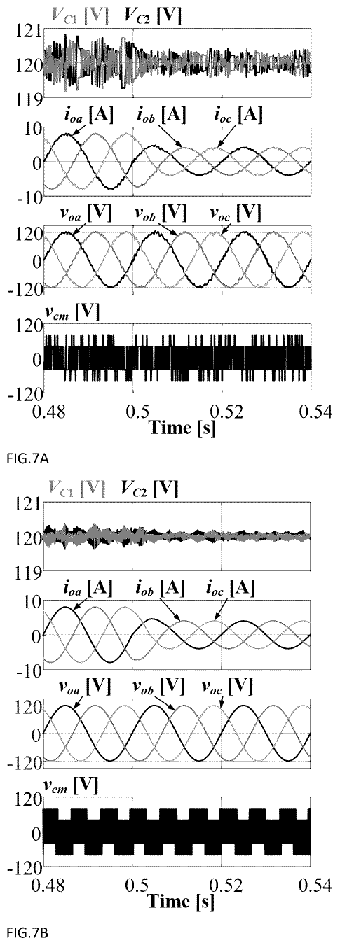

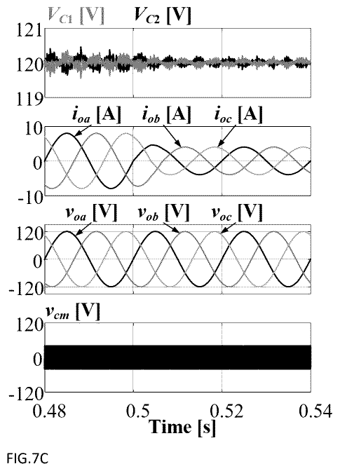

FIG. 7A, FIG. 7B, and FIG. 7C show DRWs of the load voltage and the load current of the RSC-TLI applicable to a standby power supply system according to the present invention by using single-vector model predictive control, optimal switching sequence model predictive control, and low common-mode model predictive control proposed in the present invention. It can be seen from the waveform that, in the proposed method, when load switching occurs, a constant alternating output voltage may be maintained, and a low-voltage ripple and a quick and stable dynamic response are also implemented.

Therefore, the high-performance regulation method of low common-mode model predictive control in the present example, applied to the RSC-TLI for the standby power supply system, may reduce the common-mode voltage and improve system reliability. A concept of the virtual vector is introduced, and a plurality of vectors is used to fit the expected output voltage, thereby reducing the voltage ripple and improving power quality of the output voltage. The value function is adopted to calculate the acting time of the voltage vector required to synthesize the predicted value of the load voltage at the moment k+1, to further reduce the voltage ripple. The switching sequence is ingeniously designed to achieve the fixed switching frequency, thereby facilitating efficient filtering of the voltage harmonics. The switching sequence is flexibly selected to implement neutral-point potential balance on the direct current side. The method for determining the optimal sector in the 60° coordinate system avoids complex trigonometric function calculation through simple value comparison, thereby greatly reducing complexity of the control algorithm. This achieves high-reliability and high-performance control, is easy to implement, has strong practicality, and has broad application prospects in industrial fields such as standby power supply system.

### Example 2

The present example provides a system for regulating a RSC-TLI for a standby power supply system, including:
an expected output voltage calculation module, configured to: obtain a load voltage and current, an inductor current, and upper and lower capacitor voltages on a direct current side of the RSC-TLI at a current moment, and calculate an expected output voltage;
a vector candidate set determining module, configured to: optimize a vector candidate set by avoiding high common-mode voltage vectors, and synthesize, based on discrete space vector modulation, a virtual small vector and a virtual medium vector to extend the vector candidate set, to obtain an updated vector candidate set;
an optimal sector determining module, configured to respectively determine, based on an amplitude relationship and a boundary condition of the expected output voltage in a 60° coordinate system, an optimal large sector and an optimal small sector at which the expected output voltage is located;
an initial switching sequence design module, configured to determine an initial switching sequence in the optimal small sector based on the updated vector candidate set and a voltage difference across capacitors on the direct current side;
a neutral-point voltage balance and switching sequence optimization module, configured to: calculate an optimal acting time of a selected basic voltage vector with a target of minimizing a load voltage tracking error, and optimize the initial switching sequence based on minimizing a quantity of switching actions and balancing a neutral-point voltage on the direct current side, to obtain an optimal switching sequence; and
a drive signal conversion module, configured to convert the optimal switching sequence that is output into a PWM drive signal that controls a power switching device of the RSC-TLI to be turned on and turned off.

The regulation system further includes a drive circuit, a protection circuit, and a signal sampling and conditioning circuit.

A high-performance regulator of the RSC-TLI applicable to the standby power supply system is connected to the drive circuit, and a PWM drive signal output by the high-performance regulator is sent to a gate of the power switching device through the drive circuit, to control the power switching device to be turned on and turned off. An output signal of the RSC-TLI applicable to the standby power supply system is connected to the high-performance regulator through the signal sampling and conditioning circuit. The protection circuit implements functions of over-current and over-voltage protection.

The signal sampling and conditioning circuit is responsible for sampling upper and lower capacitor voltages (V_{C1} and V_{C2}), inductor currents (iₐ, iₚ, and i_{c}), output reference voltages (

$${v}_{o a}^{*} , {v}_{o b}^{*} , and {v}_{o c}^{*}$$

), load currents (iₒₐ, i_{ob}, and i_{oc}), and load voltages (vₒₐ, v_{ob}, and v_{oc}) of a distributed direct current power supply unit.

The above modules have same examples and application scenarios in which the corresponding steps are implemented, but are not limited to content disclosed in Example 1. It should be noted that, as a part of the system, the foregoing modules may be executed in, for example, a computer system having a group of computer executable instructions.

In the foregoing examples, the descriptions of the examples have their respective focuses. For a part that is not described in detail in an example, refer to related descriptions in other examples.

The proposed system may be implemented in other manners. For example, the system examples described above are merely examples. For example, division into the modules is merely a logical function division and there may be other division in actual implementation mode. For example, a plurality of modules may be combined or integrated into another system, or some features may be ignored or not performed.

### Example 3

The present example provides a computer-readable storage medium, having a computer program stored thereon, wherein when the program is executed by a processor, the steps of the method for regulating the RSC-TLI for the standby power supply system according to Example 1 are implemented.

### Example 4

The present example provides a computer device, including a memory, a processor, and a computer program that is stored in the memory and that can be run on the processor, where when the processor executes the program, the steps of the method for regulating the RSC-TLI for the standby power supply system according to Example 1 are implemented.

### Example 5

The present example provides a computer program product or a computer program, and the computer program product or the computer program includes computer instructions; wherein, the computer instructions are stored in a computer-readable storage medium, a processor of a computer device reads the computer instructions from the computer-readable storage medium, and the processor executes the computer instructions, to cause the computer device to perform the steps of the method for regulating the RSC-TLI for the standby power supply system according to Example 1.

A person skilled in the art should understand that the examples of the present invention may be provided as a method, a system, or a computer program product. Therefore, the present invention may use a form of hardware examples, software examples, or examples with a combination of software and hardware. Moreover, the present invention may use a form of a computer program product that is implemented on one or more computer-usable storage media (including but not limited to a disk memory, an optical memory, and the like) that include computer-usable program code.

The present invention is described with reference to the flowcharts and/or block diagrams of the method, the device (system), and the computer program product according to the examples of the present invention. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions may alternatively be stored in a computer-readable memory that can instruct the computer or another programmable data processing device to work in a specific manner, so that the instructions stored in the computer-readable memory generate an artifact that includes an instruction apparatus. The instruction apparatus implements a specified function in one or more procedures in the flowcharts and/or in one or more blocks in the block diagrams.

These computer program instructions may alternatively be loaded onto the computer or another programmable data processing device, so that a series of operational steps are performed on the computer or another programmable device for a process implemented by the computer. Therefore, the instructions executed on the computer or another programmable device provides steps for implementing the specified function in one or more procedures in the flowcharts and/or in one or more blocks in the block diagrams.

A person of ordinary skill in the art may understand that all or some of the procedures of the methods of the foregoing examples may be implemented by a computer program instructing relevant hardware. The program may be stored in a computer-readable storage medium. When the program is executed, the procedures of the examples of the foregoing methods can be included. The foregoing storage medium may include a magnetic disc, an optical disc, a read-only memory (Read-Only Memory, ROM), a random access memory (Random Access Memory, RAM), or the like.

The specific implementation modes of the present invention are described above with reference to the accompanying drawings, but are not intended to limit the protection scope of the present invention. A person skilled in the art should understand that various modifications or deformations may be made without creative efforts based on the technical solutions of the present invention, and such modifications or deformations shall fall within the protection scope of the present invention.

1. A method for regulating a low-cost inverter for a standby power supply system, comprising:
obtaining a load voltage and current, an inductor current, and upper and lower capacitor voltages on a direct current side of a low-cost three-level inverter (TLI) at a current moment, and calculating an expected output voltage;
optimizing a vector candidate set by avoiding high common-mode voltage vectors, and synthesizing, based on discrete space vector modulation, a virtual small vector and a virtual medium vector to extend the vector candidate set, to obtain an updated vector candidate set;
respectively determining, based on an amplitude relationship and a boundary condition of the expected output voltage in a 60° coordinate system, an optimal large sector and an optimal small sector at which the expected output voltage is located;
determining an initial switching sequence in the optimal small sector based on the updated vector candidate set and a voltage difference across capacitors on the direct current side;
calculating an optimal acting time of a selected basic voltage vector with a target of minimizing a load voltage tracking error, and optimizing the initial switching sequence based on minimizing a quantity of switching actions and balancing a neutral-point voltage on the direct current side, to obtain an optimal switching sequence; and
generating a corresponding drive signal based on the optimal switching sequence, to control a switching device of the low-cost TLI to be turned on and turned off.

2. The method for regulating the low-cost inverter for the standby power supply system according to claim 1, wherein obtaining the load voltage and current, the inductor current, and the upper and lower capacitor voltages on the direct current side of the low-cost TLI at the current moment, and calculating the expected output voltages
$${V}_{g}^{*} ( k ) and {V}_{h}^{*} ( k ) :$$
$$\{ \begin{matrix}{V}_{g}^{*} ( k ) = \frac{{L}_{f}}{{T}_{s}} ( \frac{{C}_{f}}{{T}_{s}} {E}_{g} + {i}_{o g} ( k ) - {i}_{g} ( k ) ) + {v}_{o g} ( k ) \\ {V}_{h}^{*} ( k ) = \frac{{L}_{f}}{{T}_{s}} ( \frac{{C}_{f}}{{T}_{s}} {E}_{h} + {i}_{o h} ( k ) - {i}_{h} ( k ) ) + {v}_{o h} ( k )\end{matrix} ;$$
wherein i_{og} and iₒₕ respectively represent values of the load current in the 60° coordinate system, i_{g} and iₕ respectively represent values of the inductor current in the 60° coordinate system, v_{og} and vₒₕ are coordinates of the load voltage in the 60° coordinate system, Tₛ represents a sampling period,
$${E}_{g} = {V}_{og}^{*} ( k + 1 ) - {V}_{og} ( k ) ,$$
$${E}_{h} = {V}_{oh}^{*} ( k + 1 ) - {V}_{oh} ( k ) ,$$
predicted values of a reference voltage at a moment k+1 are
$${V}_{og}^{*} ( k + 1 ) and {V}_{oh}^{*} ( k + 1 ) ,$$
predicted values of the load voltage at the moment k+1 are V_{og}(k+1) and Vₒₕ(k+1), L_{f} and C_{f} are a filter inductor and a filter capacitor respectively, k is the current moment, i_{og}(k) and iₒₕ(k) are expressions of the load current in the 60° coordinate system at the moment k, i_{g}(k) and iₕ(k) are expressions of the inductor current in the 60° coordinate system at the moment k, and v_{og}(k) and v_{og}(k) are expressions of the load voltage in the 60° coordinate system at the moment k.

3. The method for regulating the low-cost inverter for a standby power supply system according to claim 1, wherein optimizing the vector candidate set by avoiding the high common-mode voltage vectors, and synthesizing, based on the discrete space vector modulation, the virtual small vector and the virtual medium vector to extend the vector candidate set, to obtain the updated vector candidate set is specifically:
avoiding the high common-mode voltage vectors, and synthesizing the virtual small vector by using three basic voltage vectors, a sum of neutral-point currents generated by the three basic voltage vectors being opposite in polarity but equal in amplitude to a neutral-point current generated by an actual small vector corresponding to the virtual small vector;
synthesizing the virtual medium vector by using two large vectors as basic voltage vectors; and
obtaining the updated vector candidate set based on the virtual small vector and the virtual medium vector.

4. The method for regulating the low-cost inverter for the standby power supply system according to claim 1, wherein the respectively determining, based on the amplitude relationship and the boundary condition of the expected output voltage in the 60° coordinate system, the optimal large sector and the optimal small sector at which the expected output voltage is located is specifically:
performing normalization processing on
$${V}_{g}^{*} ( k ) and {V}_{h}^{*} ( k )$$
based on V_{dc}/3, to obtain expected output voltages
$${V}_{g}^{\hat{}} ( k ) and {V}_{h}^{\hat{}} ( k )$$
on which normalization processing is performed:
$$\{ \begin{matrix}{V}_{g}^{\hat{}} ( k ) = {V}_{g}^{*} ( k ) / ( {V}_{dc} / 3 ) \\ {V}_{h}^{\hat{}} ( k ) = {V}_{h}^{*} ( k ) / ( {V}_{dc} / 3 )\end{matrix} ;$$
wherein expected output voltages of the low-cost TLI in the 60° coordinate system are and
$${V}_{g}^{*} ( k )$$
and
$${V}_{h}^{*} ( k ) ,$$
a direct current side voltage is V_{dc}, and k is the current moment; and a relational expression of expected output voltages
$${V}_{g}^{R} ( k ) and {V}_{h}^{R} ( k )$$
obtained after sector conversion and the expected output voltages
$${V}_{g}^{\hat{}} ( k ) and {V}_{h}^{\hat{}} ( k )$$
on which the normalization processing is performed is as follows:
$$[ \begin{matrix}{V}_{g}^{R} ( k ) \\ {V}_{h}^{R} ( k )\end{matrix} ] = {[ \begin{matrix}1 & 1 \\ - 1 & 0\end{matrix} ]}^{N - 1} [ \begin{matrix}{V}_{g}^{\hat{}} ( k ) \\ {V}_{h}^{\hat{}} ( k )\end{matrix} ] ;$$
determining, based on an amplitude relationship, in the 60° coordinate system, of the expected output voltage on which the normalization processing is performed, the optimal large sector at which the expected output voltage is located; and
determining, based on a boundary condition, in the 60° coordinate system, of the expected output voltage obtained after sector conversion, the optimal small sector at which the expected output voltage is located.

5. The method for regulating the low-cost inverter for the standby power supply system according to claim 1, wherein the calculating the optimal acting time of the selected basic voltage vector with the target of minimizing a load voltage tracking error is specifically:
$$\{ \begin{matrix}\frac{\partial J ( {t}_{1} , {t}_{2} )}{\partial {t}_{1}} = 0 \\ \frac{\partial J ( {t}_{1} , {t}_{2} )}{\partial {t}_{2}} = 0\end{matrix} ;$$
wherein J is an output voltage tracking error target function, and t₁ and t₂ are respectively acting times of voltage vectors Vᵥ₁ and Vᵥ₂; and
$$J = \vert {v}_{og}^{*} ( k + 1 ) - {v}_{og} ( k + 1 ) \vert + \vert {v}_{oh}^{*} ( k + 1 ) - {v}_{oh} ( k + 1 ) \vert$$
predicted values of the load voltage in the 60° coordinate system at a moment k+1 are v_{og}(k+1) and vₒₕ(k+1), and reference values of a reference voltage at the moment k+1 are
$${v}_{og}^{*} ( k + 1 ) and {v}_{oh}^{*} ( k + 1 ) .$$

6. The method for regulating the low-cost inverter for the standby power supply system according to claim 1, wherein the optimizing the initial switching sequence based on minimizing the quantity of switching actions and balancing the neutral-point voltage on the direct current side, to obtain the optimal switching sequence is specifically:
selecting a switching sequence comprising an N-type small vector when the neutral-point voltage on the direct current side is high;
selecting a switching sequence comprising a P-type small vector when the neutral-point voltage on the direct current side is low;
designing, on the premise of minimizing the quantity of switching actions, a seven-segment or five-segment symmetric switching sequence, to ensure that switching sequences of a same type have a consistent quantity of actions; and
obtaining the optimal switching sequence based on foregoing rules.

7. A system for regulating a low-cost inverter for a standby power supply system, comprising:
an expected output voltage calculation module, configured to: obtain a load voltage and current, an inductor current, and upper and lower capacitor voltages on a direct current side of the low-cost TLI at a current moment, and calculate an expected output voltage;
a vector candidate set determining module, configured to: optimize a vector candidate set by avoiding high common-mode voltage vectors, and synthesize, based on discrete space vector modulation, a virtual small vector and a virtual medium vector to extend the vector candidate set, to obtain an updated vector candidate set;
an optimal sector determining module, configured to respectively determine, based on an amplitude relationship and a boundary condition of the expected output voltage in a 60° coordinate system, an optimal large sector and an optimal small sector at which the expected output voltage is located;
an initial switching sequence design module, configured to determine an initial switching sequence in the optimal small sector based on the updated vector candidate set and a voltage difference across capacitors on the direct current side;
a neutral-point voltage balance and switching sequence optimization module, configured to:
calculate an optimal acting time of a selected basic voltage vector with a target of minimizing a load voltage tracking error, and optimize the initial switching sequence based on minimizing a quantity of switching actions and balancing a neutral-point voltage on the direct current side, to obtain an optimal switching sequence; and
a drive signal conversion module, configured to generate a corresponding drive signal based on the optimal switching sequence, to control a switching device of the low-cost TLI to be turned on and turned off.

8. A computer-readable storage medium, having a computer program stored thereon, wherein when the program is executed by a processor, implementing the steps of the method for regulating the low-cost inverter for the standby power supply system according to claim 1.

9. A computer device, comprising a memory, a processor, and a computer program that is stored in the memory and that may be run on the processor, wherein when the processor executes the program, implementing the steps of the method for regulating the low-cost inverter for the standby power supply system according to claim 1.

10. A computer program product, comprising a computer program, wherein when the computer program is executed by a processor, implementing the steps of the method for regulating the low-cost inverter for the standby power supply system according to claim 1.
